(19) United States
(12) Patent Application Publication
(10) Pub. No.: US 2007/0143396 A1
(43) Pub. Date: Jun. 21, 2007

(54) Method for client-server-based communication over several interfaces and client supporting the method

(76) Inventors: Kalyan Koora, Bocholt (DE); Mirko Naumann, Geretsried (DE)

Correspondence Address: SLATER & MATSIL, L.L.P., 17950 PRESTON RD, SUITE 1000, DALLAS, TX, 75252-5793, US

(21) Appl. No.: 11/635,382

(22) Filed: Dec. 7, 2006

(30) Foreign Application Priority Data
Dec. 9, 2005 (EP) 05026958.8

(51) Int. Cl. G06F 15/16

(52) U.S. Cl. 709/203

(57) ABSTRACT

A method for communication between a client (CL) and a server (SV) using a client that is able to use one of at least two interfaces (INTF1, INTF2, . . . , INTFN) and to switch between these interfaces (INTF1, INTF2, . . . , INTFN) during a communication session. The client (CL) uses a local proxy (LSP) to take care of appropriate re-registration with the server (SV) when the client switches between two interfaces (INTF1, INTF2, . . . , INTFN).

This application claims priority to European Patent Application 05026958.8, which was filed Dec. 9, 2005 and is incorporated herein by reference.

### TECHNICAL FIELD

The method refers generally to communications and in a specific environment to a method for client-server-based communication over several interfaces and client supporting the method.

### BACKGROUND

Various protocols are known for client-server-based communication, supporting sessions with two or more than two participants like conferencing, etc. A very important and widely used protocol for client-server-based communication is the so called Session Initiation Protocol

Session Initiation Protocol (SIP) is used to signal and control interactive multimedia sessions in the fixed line network as well as in the mobile network of third generation. It is a signalling protocol for Internet conferencing, telephony, presence, event notification and instant messaging. SIP enables user mobility through a mechanism that allows requests to be proxied or redirected to the user's current location. Users can register their current location with their home server. SIP is independent of the lower-layer transport protocol, which allows SIP to take advantage of new transport protocols. Presently, this protocol supports mobility of the user by registering the user's location (e.g., IP address) over an interface of a terminal which is kept constant through out the registration.

Even for sessions it is assumed that the interface that is chosen for the user data (user plane) will not change while the session is active. When the user moves to another device (e.g., other PC or other mobile device) by a new registration process, the user binds the new IP address to his globally unique SIP address. Afterwards the user can be reached via the new device. For UMTS multimedia sessions and IP based services a new network was introduced by 3GPP. The IMS (i.e., IP Multimedia Subsystem) uses SIP as a signalling protocol for multimedia sessions (like PoC or VoIP) as well as the transport of presence information and the exchange of Instant Messages.

Now, in a mobile environment (with mobile terminals) the terminal may have several interfaces (i.e., a so called Multimode Terminal-MMT), e.g., WLAN, UMTS, GPRS . . . and the IMS can be reached via several (air-)interfaces. By moving around, the signal strength for the interfaces may vary. This leads to the situation that a link (used for signalling) may be lost. While this is just noticed by a lower layer (interface layer), the SIP registration and possibly the SIP session will have to be renewed/updated. Accordingly, the SIP stack and/or application would have to provide a specific interface to receive a specific notification. Afterwards the stack and/or the application must update the registration and all running sessions. This would make an application and/or the SIP stack dependent on the kind of terminal (Multimode or not). Although Mobile IP (MIP) aims to introduce mobility, the change in interface and the IP address must be forwarded to all the modules and applications. This implicitly implies that the user would have to interact and to activate the new connection.

### SUMMARY OF THE INVENTION

The current invention aims at improving this communication between a client and a server. This is achieved by a method or apparatus according to one of the claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 shows a state-of-the-art of SIP signalling;

FIG. 2 shows an enhancement of SIP signalling with LSP;

FIG. 3 shows an example scenario;

FIG. 4 shows a possible position of the new module within the MMT; and

FIG. 5 shows a typical configuration according to the present invention.

### DETAILED DESCRIPTION OF ILLUSTRATIVE EMBODIMENTS

According to an embodiment, a method for communication between a client (CL) and a server (SV) comprises a method wherein the client is able to use one of several—i.e. at least two—interfaces (INTF1, INTF2, . . . , INTFN) and to switch between these interfaces (INTF1, INTF2, . . . , INTFN) during a communication session. The method includes the client (CL) using a local proxy (LSP) that takes care for appropriate re-registration with the server (SV) when the client switches between the interfaces (INTF1, INTF2, . . . , INTFN).

The method of the kind explained above may comprise that the local proxy (LSP) also takes care of modifying messages if necessary to avoid any disturbance in the communication session caused by the switching between interfaces.

A client (CL) set up for communication with a server (SV) over one of several interfaces (INTF1, INTF2, . . . , INTFN) with the ability to switch between these interfaces (INTF1, INTF2, . . . , INTFN) during a communication session may use a local proxy (LSP) taking care for appropriate re-registration with the server (SV) when the client switches between two interfaces (INTF1, INTF2, . . . , INTFN).

The client of the kind explained before may use a local proxy (LSP) to also take care of modifying messages if necessary to avoid any disturbance of the communication session caused by the switching between interfaces.

The embodiment of the method proposes the introduction of a new module within the MMT. The new module is enhanced with an intelligent functionality, which is capable of handing over the SIP signalling to other interfaces depending on the preferences. This is achieved by sending an automatic re-register to the Registrar. Following SIP requests sent out by the SIP stack will be modified so that the interface address being used is always correct. This keeps the user connected to the IMS/SIP network and able to use the IMS/SIP services. The embodiment offers a way to keep the IMS/SIP application and the SIP stack independent of the specific behavior necessary for a MMT.

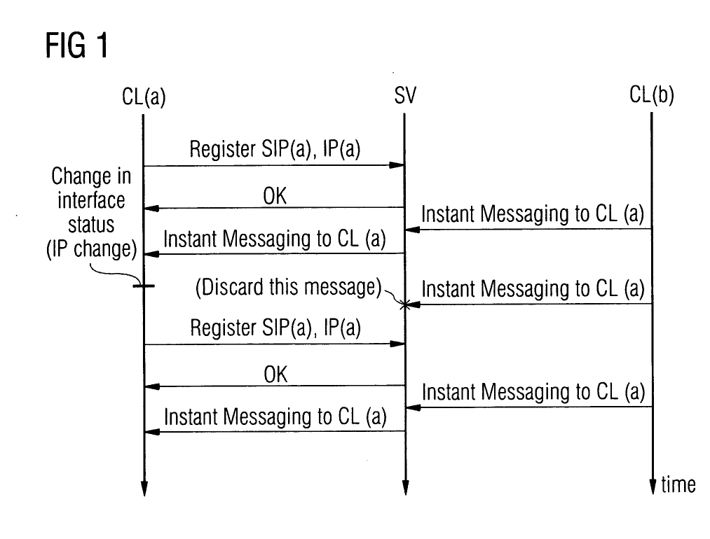

FIG. 1 shows the state-of-the-art for SIP signalling. As shown, the MMT (terminal A or CL (a)) directly contacts the IMS (SV). For the sake of understanding, it is assumed that the IMS comprises all the required components like Registrar, Proxy, Re-Direct server, etc. User A (of terminal A) sends a registration to IMS (SV). Afterwards all services (Presence, Instant Messages, Sessions, PoC) can be used. If the link to IMS breaks or changes, the mobile terminal of user A is not reachable anymore. This means that IMs, session invitations, presence updates sent by or via IMS will not reach user A and user A will not have any information about this (until the registration times out and is renewed). In this case the IMS server could discard the messages directed to terminal A.

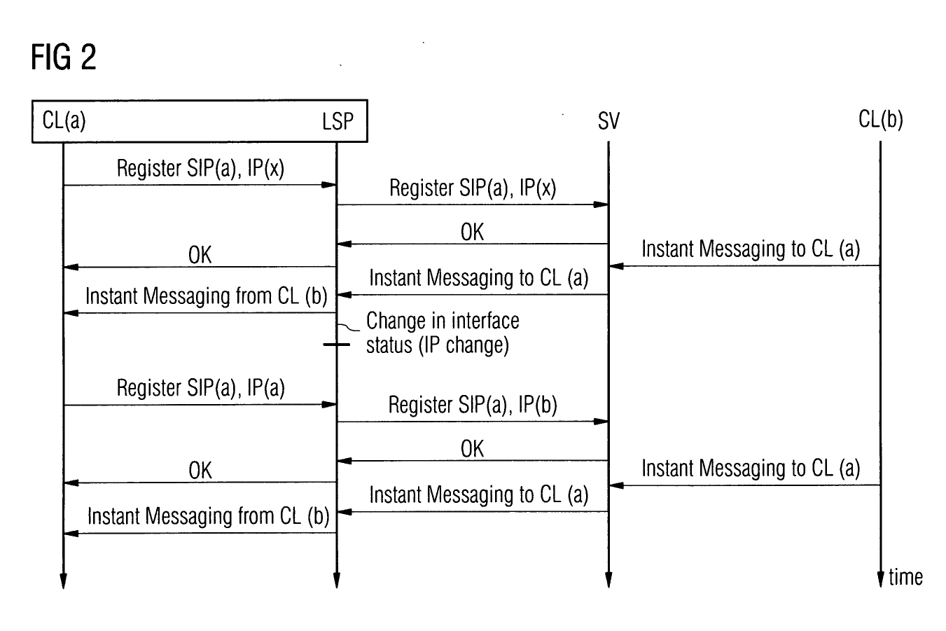

In contrast to the standard concept, the preferred embodiment introduces a new module within the MMT. This is shown in FIG. 2. The SIP stack will be configured such that it communicates with the new module as this new module would be a local SIP proxy (LSP) and sends its contact details like SIP and IP address. In case of IP address (designated in FIG. 2 as ‘IP(x)’), the SIP stack randomly selects one from a set of available IP addresses. (Note that in a MMT each interface has an IP address). This IP address could be, for example, the local IP address (127.0.0.1). The LSP modifies the messages sent by the SIP stack according to the needs and transmits the correct information to the IMS server.

As shown above, if there is a change in the interface, LSP takes care of the re-registration with the IMS server. Thus, the LSP is in a position to handle all the interfaces and control the handover mechanisms without disturbing the SIP registration.

Introducing the new module in a terminal can lead at least to some of the following advantages:

All the standard signalling mechanisms are supported, since the terminal conforms with the standard.

Since the SIP stack usually contacts a SIP proxy, no special changes have to be made to the stack.

The new module takes care of handing over the signalling to an active interface, if interfaces are coming up and going down.

SIP (Re-)Registration are carried out through the new module automatically.

The new module changes the SIP messages regarding the current configuration (IP, ports . . . )

The new module is transparent to the applications and acts as a gateway.

FIG. 5 shows one possible configuration of a client (CL) that can communicate with a server (SV) via a number of interfaces (INTF 1, INTF2, . . . , INTFN) through the LSP.

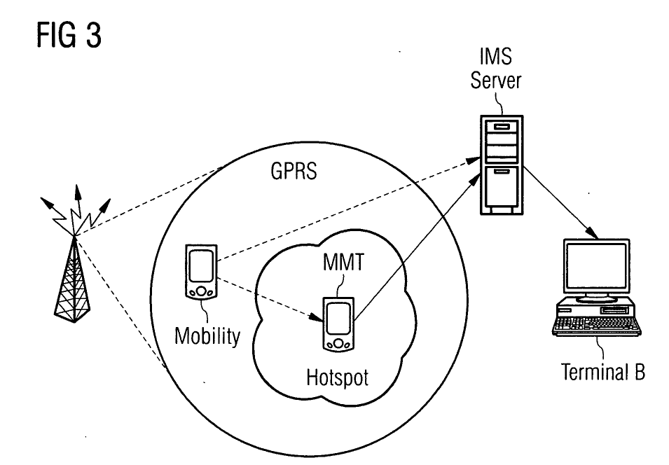

We discuss the idea with help of a scenario as depicted in FIG. 3.

It is assumed that the MMT has two interfaces, GPRS and WLAN. Three or more interfaces are also useful. Being outside of a WLAN hotspot, the MMT would like to establish a SIP session with terminal B (also designated as CL (b) in other figures) over the GPRS interface. GPRS is a General Packet Radio Service that delivers data with data packets. WLAN is a wireless local area network. At this point the WLAN interface is inactive. It is also assumed that the MMT is enhanced with the new LSP module. The MMT registers itself at the IMS server its location using the new module. After that, an Instant Message, sent by terminal B can be exchanged in the standard SIP procedure. Now the MMT moves into a WLAN hotspot and gets itself registered with the hotspot and activates its WLAN interface. Since the user of the MMT prefers the WLAN over GPRS interface, now the new module carries the re-registration process over the WLAN interface and updates its database at the IMS server so that it can be accessed by terminal B.

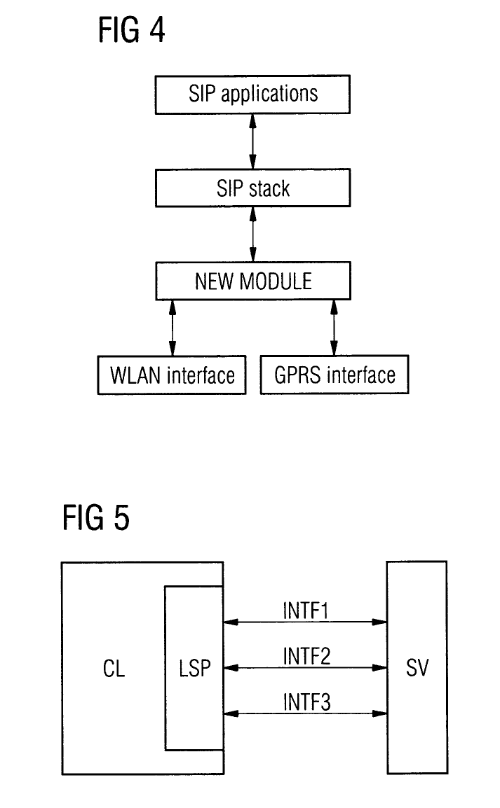

FIG. 4 shows the position of the new module within the multi-mode terminal. The new module is in charge of handling all the registration signalling over the appropriate interface.

What is claimed is:

1. A method of communicating between a client and a server, the method comprising:
carrying on a communication session between the client and the server through a first interface;
switching from the first interface to a second interface during the communication session; and
re-registering the client with the server when switching from the first interface to the second interface the re-registering being taken care of using a local proxy at the client.

2. The method of claim 1, wherein the local proxy also takes care of modifying messages to avoid any disturbance of the communication session caused by the switching between the first interface and the second interface.

3. The method of claim 1, wherein a session initiation protocol stack sends its contact details in response to switching from the first interface to the second interface.

4. The method of claim 3, wherein the session initiation protocol stack selects one from a set of available IP addresses.

5. The method of claim 4, wherein selecting comprises selecting a local IP address and wherein the local proxy modifies the message sent by the session initiation protocol stack.

6. The method of claim 5, further comprising transmitting the modified message to the server.

7. The method of claim 1, wherein the server is configured as an IP multimedia subsystem server.

8. The method of claim 7, wherein the local proxy re-registers with the IP multimedia subsystem server.

9. The method of claim 1, wherein the first interface comprises one of a GPRS interface or a WLAN interface and the second interface comprises the other one of a GPRS interface or a WLAN interface.

10. The method of claim 1, wherein the first interface comprises a GPRS interface and the second interface comprises a WLAN interface and wherein the client switches from the GPRS interface to the WLAN interface when it reaches a WLAN service node.

11. The method of claim 1, wherein the first interface comprises a GPRS interface and the second interface comprises a WLAN interface and wherein the client switches from a WLAN interface to a GPRS interface when it leaves the reception area of a WLAN service node.

12. A method for communication between a client and a server, the method comprising:
providing a client that uses one of two or more interfaces and to switch between the two or more interfaces during a communication session; and
at the client, using a local proxy taking care of appropriate re-registration with the server when the client switches between the two or more interfaces.

13. A client for communication with a server, the client comprising:
a first interface;
a second interface; and
a local proxy between the client module and the first and second interfaces;
wherein the client is set up for communication with the server over at least the first interface and the second interface with the ability to switch between these interfaces during a communication session; wherein the local proxy takes care of re-registration with the server when the client switches between the first interface and the second interface.

14. The client of claim 13, wherein the local proxy also takes care of modifying messages to avoid any disturbance of the communication session caused by the switching between interfaces.

15. The client of claim 14, wherein the first interface comprises a GPRS interface and the second interface comprises a WLAN interface.
